(19) United States
(12) Patent Application Publication
(10) Pub. No.: US 2009/0218371 A1
(43) Pub. Date: Sep. 3, 2009

(54) Sluice Vessel and Method of Operating Such a Sluice Vessel

(76) Inventor: Wouter Detlof Berggren, Amsterdam (NL)

Correspondence Address: SHELL OIL COMPANY, P O BOX 2463, HOUSTON, TX, 772522463, US

(21) Appl. No.: 10/550,361

(22) PCT Filed: Mar. 23, 2004
(86) PCT No.: PCT/EP04/50347

§ 371 Date: Oct. 25, 2007

(30) Foreign Application Priority Data
Mar. 25, 2003 (EP) 03075882.5

(51) Int. Cl. B65G 69/06

(52) U.S. Cl. 222/195

(57) ABSTRACT

Sluice vessel (1) for feeding solid particulates into a pressurized pressure vessel, the sluice vessel (1) having a low pressure state and a high pressure state, the sluice vessel (1) comprising means for charging the sluice vessel with a load of the solid particulates when the sluice vessel is in its low pressure state, at least one discharge port (4), and pressurising means (6) for increasing the pressure inside the vessel by bringing a pressurising fluid into the vessel, to bring the vessel into its high pressure state before discharging the load via the discharge port (4), whereby the pressurising means (6) comprises one or more pressurising fluid inlet means arranged to be submerged under the load of solid particulates.

The present invention relates to a sluice vessel for feeding solid particulates into a pressurized pressure vessel.

Such a sluice vessel may be used in a gasification plant, wherein a pulverised carbonaceous fuel, such as coal, is transformed into synthesis gas.

Such a gasification plant can comprise an atmospheric powder coal storage vessel, a sluice vessel, a pressurized powder coal storage vessel, and a gasification reactor. In operation, the powder coal is charged from the powder coal storage vessel into, the sluice vessel at atmospheric pressure. Then the sluice vessel is closed and pressurised.

After the pressure in the sluice vessel is essentially equal to or somewhat higher than that in the pressurized powder coal storage vessel, the load of powder coal is charged into the pressurized powder coal storage vessel. Hence, the pressurized powder coal storage vessel is supplied with powder coal load by load in a batch wise manner.

To facilitate a continuous flow of powder coal from the pressurized powder coal storage vessel to the gasification reactor, the pressure in the pressurized powder coal storage vessel is desirably higher than the operating pressure inside the gasification reactor. Thus, a continuous supply of powder coal from the pressurized powder coal storage vessel to the gasification reactor is feasible, provided that the batch loading of the pressurized powder coal storage vessel occurs at sufficiently high repetition rate to replenish the supply of powder coal in the pressurized powder coal storage vessel before it is empty. In the above-described configuration, the powder coal storage vessel thus acts as an accumulator to receive and store the batches that are released by the sluice vessel, and continuously release its content.

In practice, the operating pressure in the gasification reactor is as high as tens of bars. Consequently, the sluice vessel must normally be cycled between atmospheric pressure and tens of bars.

A problem recognised in U.S. Pat. No. 4,067,623 with typical sluice vessels for pressurising fine particulate materials is that the fine material undergoes marked compaction during pressurisation of the sluice vessel, often resulting in a tendency of the fine material to form bridges. In the mentioned US patent, it is proposed to solve this problem by provision of an aerating cone in the sluice vessel provided with a; number of nozzles, uniformly distributed over the length and periphery of its casing. When the fine material has been heavily compacted after pressurisation of the sluice, and is to be moved from the sluice vessel to the storage vessel, the nozzles in the aerating cone are pressurised with gas which can pass through said nozzles deeply into the fine material and hence cause effective loosening of the material by breaking up the compacted mass, so that bridge-formation can be prevented.

This solution has various drawbacks. It has been found that the compacted material does not in all cases effectively break up, thus still causing bridge-formation during discharging.

Another drawback is that the breaking of the compacted material is time consuming.

It is still another drawback that, in particular where the particulate material tends to form bridges very readily, the aeration gas must be provided in a pulsating manner.

It is thus an object of the invention to more effectively reduce the risk of clogging up of the discharge port of the sluice vessel.

According to the invention, this object is achieved in a sluice vessel with a low pressure state and a high pressure state, the sluice vessel comprising means for charging the sluice vessel with a load of the solid particulates when the sluice vessel is in its low pressure state, at least one discharge port, and pressurising means for increasing the pressure inside the sluice vessel by bringing a pressurising fluid into the sluice vessel, to bring the sluice vessel into its high pressure state before discharging the load via the discharge port, whereby the pressurising means comprises one or more pressurising fluid inlet means arranged to be submerged under the load of solid particulates.

By introducing at least part of the pressurising fluid in the sluice vessel through the load of solid particulates, the load of solid particulates is aerated during the pressurisation of the sluice vessel. Thereby the occurrence of compaction of the load can be avoided from the onset, so that it is no longer required to break the compacted load after pressurisation. The risk of clogging up the discharge port is thereby effectively reduced, even for materials that have a particular tendency to compact, such as is the case when smaller and larger particulates are present together such as is often the case with powder coal.

The pressurising means, including the one or more submerged pressurising fluid inlet means, is also available for aerating the load of solid particulates during discharging. Aerating during the discharge reduces the risk of subsequent bridge formation, when the sluice vessel is in its high pressure state.

In an embodiment of the invention, the pressurising fluid inlet means comprises a supply passage for transporting the pressurising fluid, the supply passage being connectable to a pressurisation device. The supply passage allows for transporting the pressurising fluid to an advantageous location underneath the load of solid particulates.

The supply passage may comprise a supply passage side wall that is provided with one or more openings, perforating the supply passage side wall, for allowing passage of the pressurising fluid from the supply passage into the sluice vessel. Herewith it is achieved that a single supply passage can bring the pressurizing fluid in one or more advantageous locations underneath the load of solid particulates.

In an embodiment, the supply passage is a tubular supply passage. A tubular passage allows for a rigid construction that is resistant against the weight of the load of solid particulates. Moreover, thanks to the elongate character of a tubular passage, such a passage can be removable from the sluice vessel via a relatively small port for servicing.

In an embodiment, the tubular element can extend vertically into the load of solid particulates. Even in such geometry whereby the pressurised fluid is introduced in the load relatively locally via a tubular element the compaction of the load can effectively reduced.

Once injected into the sluice vessel, the pressurising fluid follows an essentially vertical trajectory through the solid particulates. For this reason, the tubular supply element preferably extends in a substantially off-vertical direction. Herewith the flow of pressurising fluid through the solid particulates in close vicinity of the tubular element, causing erosion on the tubular element, is avoided.

In view of avoiding the flow of pressurising fluid through the solid particulates in close vicinity of the tubular element, the more openings, provided in the tubular element side wall, face an upward direction.

Preferably, where the tubular supply passage extends along a longitudinal, straight, tube axis, the discharge port is in alignment with the longitudinal tube axis. In this geometry, the tubular supply passage least obstructs the flow of solid particulates during discharging and thereby the risk of clogging up of the discharge port is further reduced.

Preferably, the pressurising fluid inlet means is provided with a distributor comprising a porous material, preferably made of a sintered metal, for supporting the solid particulates and allowing passage of the pressurising fluid. Herewith the formation of large bubbles of pressurising fluid is avoided, which could cause excessive turbulence in the load of solid particulates and thereby enhance erosion of the sluice vessel wall and/or sluice vessel internals.

In an advantageous embodiment comprising the mentioned supply passage, the distributor is mechanically supported by the supply passage for withstanding a pressure difference across the distributor corresponding to at least the pressure difference between the low pressure state and a high pressure state. This can be achieved for instance by provision of a relatively small insert of the distributor material, for instance in the form of a disk or a plug, placed in a through opening in the supply passage.

In an embodiment, the sluice vessel has a part with a downwardly converging wall forming at an apex thereof the at least one discharge port. Herewith the discharging of the load of solid particulates is facilitated. The converging wall may be (frustro-)conically shaped, preferably having an included angle of less than 150°, more preferably having an included angle of less than 90°, more preferably less than 39°.

A discharge zone is defined inside the sluice vessel stretching vertically above the discharge port. The supply passage is preferably provided outside the discharge zone, in order to avoid unnecessary obstruction of the discharge opening by the supply passage.

The discharge zone is preferably free of obstructing parts such as the supply passage in the lower part of the sluice vessel where the converging wall is spaced horizontally away from the discharge zone.

In an advantageous embodiment, the pressurising fluid inlet means are arranged in, on, or close to the converging wall. This has various advantages. Firstly, a very good distribution of the flow of pressurising fluid through the load of solid particulates can be achieved. Moreover, due to its close vicinity, the pressurising fluid inlet means can find ample mechanical support by the sluice vessel wall. Herewith mechanical deformation of the pressurising fluid means under the load of the solid particulates can be reduced. Moreover, the supply passage and the means for providing mechanical support do not necessarily cause substantial obstruction to the outflowing content of solid particulates.

In an advantageous embodiment, the pressurising fluid inlet means are arranged to bring the pressurising fluid into the sluice vessel in a direction facing away from the nearest section of the converging wall. Herewith the flow of pressurising fluid through the solid particulates in close vicinity of the converging wall is avoided, resulting in less erosion on the wall.

In another aspect, the invention relates to a method of operating a sluice vessel for feeding solid particulates into a pressurised pressure vessel of operating a sluice vessel for feeding solid particulates into a pressurised pressure vessel, the sluice vessel comprising at least one discharge port, wherein the sluice vessel is brought from a low pressure state to a high pressure state.

The object of the invention is also achieved by the method according to the invention, comprising the steps of:

charging the sluice vessel with a load of the solid particulates when the sluice is in its low pressure state;

bringing the sluice vessel into its high pressure state, before discharging the load via the discharge port, by bringing a pressurising fluid into the sluice vessel thereby increasing the pressure inside the sluice vessel;

whereby at least part of the pressurising fluid is brought into the sluice vessel via one or more pressurising fluid inlet means submerged under the load of solid particulates.

By introducing at least part of the pressurising fluid in the sluice vessel through the load of solid particulates, the load of solid particulates is aerated during the pressurisation of the sluice vessel. As a result, adversely compressing the load by the pressurising fluid, and thus the risk of clogging up the discharge port, is reduced.

Advantageously, the same one or more pressurising fluid inlet means may be utilised for aerating the load during subsequent discharging the load via the discharge port, by allowing a flow of aeration fluid through the one or more pressurising fluid inlet means.

Preferably, the aeration fluid is actively injected into the load of the solid particulates, whereby more preferably one or both of a selected pressure and a selected volumetric rate of the aeration fluid is controlled. Herewith the discharge of the load is better facilitated and a more continuous mass flow rate is achievable.

Further embodiments of the method and their advantages are derivable from the above described sluice vessel.

The invention will described hereinafter in more detail and by way of example, with reference to the accompanying drawings in which:

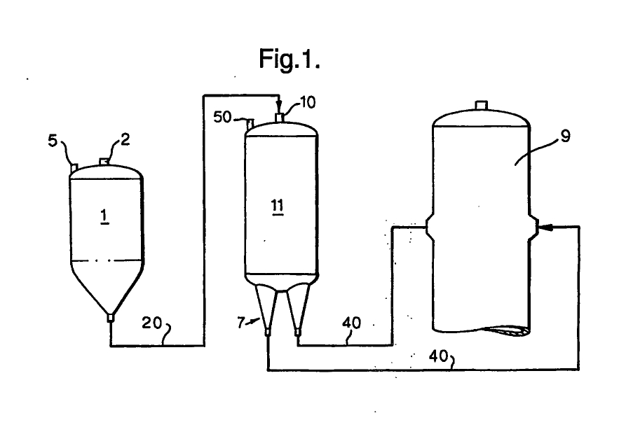

FIG. 1 schematically shows a gasification plant including a sluice vessel in accordance with the invention;

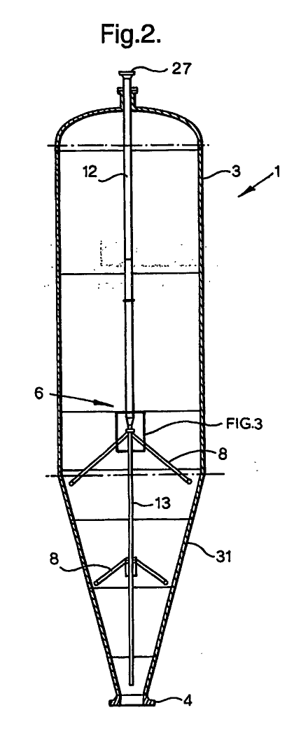

FIG. 2 schematically shows a cross sectional view of a sluice vessel according to one embodiment of the invention;

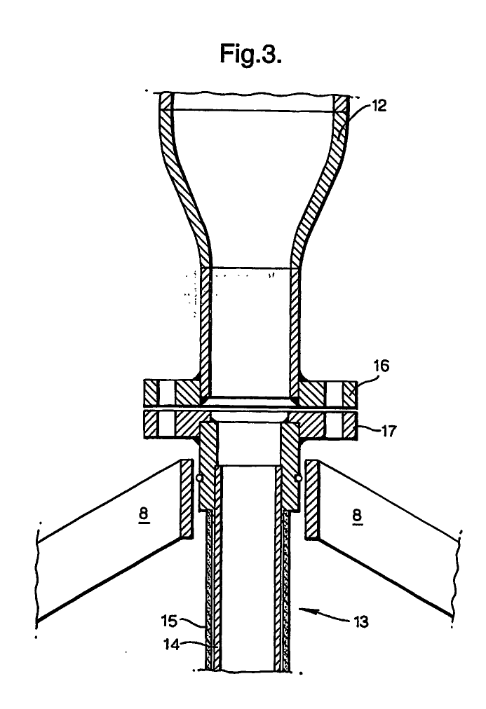

FIG. 3 schematically shows a detailed view of the indicated area in FIG. 2;

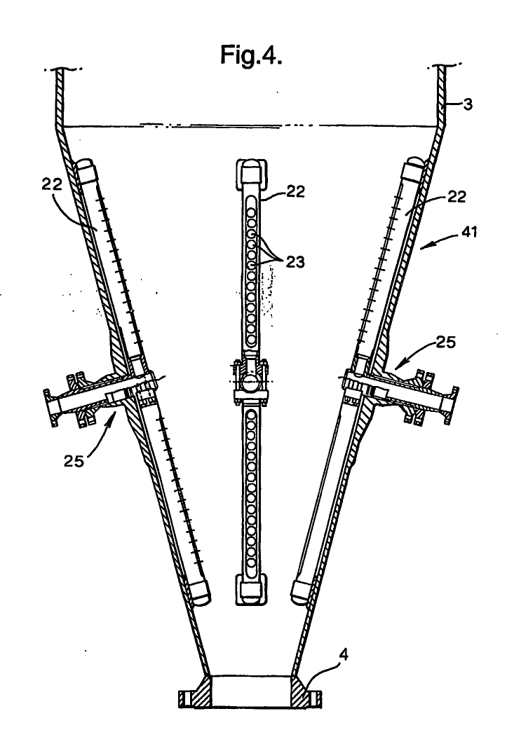

FIG. 4, schematically shows a second embodiment of the invention;

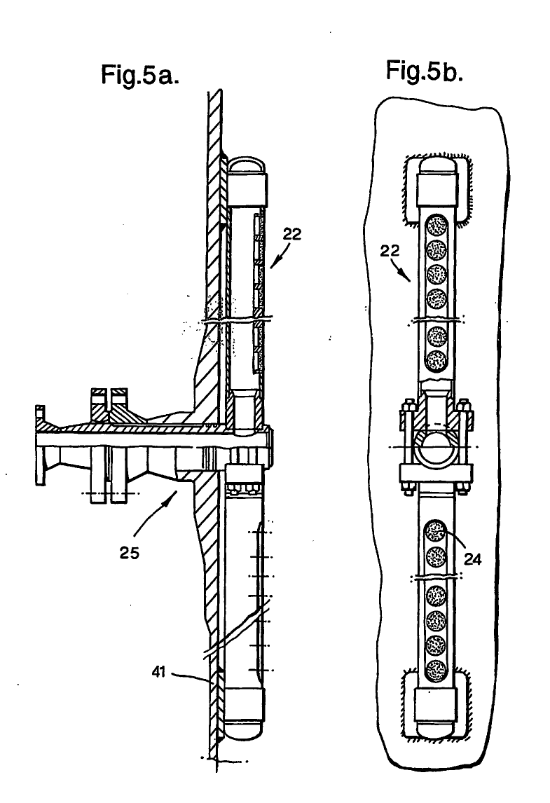

FIG. 5, shows a side view (part a) and a front view (part b) of the inlet means in accordance with the embodiment of FIG. 4;

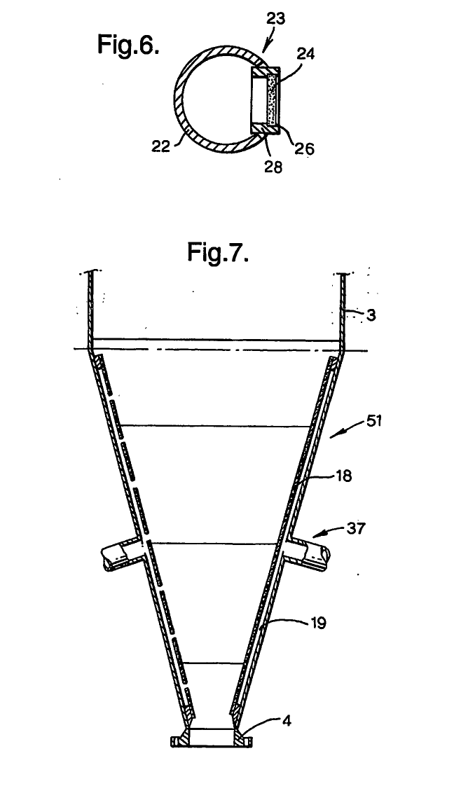

FIG. 6 schematically shows a cross sectional view of the inlet means in accordance with FIG. 5;

FIG. 7 schematically shows a detailed cross sectional view of a sluice vessel according to third and fourth embodiments of the invention.

In the Figures like reference signs relate to like components.

Although the sluice vessel in accordance with the invention can find application in other fields of technology, the sluice vessel and its operation will be described as part of a gasification plant by way of example.

Referring to FIG. 1 there is schematically shown a coal gasification plant, comprising a sluice vessel 1, a pressurized powder coal storage vessel 11, and a gasification reactor 9 for the generation of synthesis gas. The pressurized powder coal storage vessel, shown here in the form of a feed hopper, is operated at an elevated pressure that may be any pressure between 1 and 70 bar. The feed hopper 11 directs its load into generally cone-shaped receiving means 7. From there, the feed hopper 11 is connected to the gasification reactor 9 via conduits 40. Since the feed hopper 11 is pressurised during normal operation, a continuous feed flow of the powder coal to the gasification reactor 9 is maintainable.

Generation of synthesis gas occurs by partially combusting a carbonaceous fuel, such as coal, at relatively high temperatures in the range of 1000° C. to 3000° C. and at a pressure range of from about 1-70 bar, in the presence of oxygen or oxygen-containing gases in the coal gasification reactor. The fuel and gas mixture is discharged from the feed hopper 11, preferably having multiple outlets 7, each outlet being in communication with at least one burner associated with the reactor. Typically, the pressure inside the feed hopper 11 exceeds the pressure inside the reactor 9, in order to facilitate injection of the powder coal into the reactor. Typically, a reactor will have burners in diametrically opposing positions, but this is not a requirement of the present invention.

The sluice vessel 1 is connected to an inlet port 10 of the feed hopper 11 via conduit 20. The sluice vessel contains an inlet port 2 which may be connected to an atmospheric powder coal storage vessel (not shown). Also provided is an inlet port 5 for introducing and releasing a pressurisation fluid to the sluice vessel. In particular a gaseous pressurisation fluid is suitable.

Preferably an inert gas such as nitrogen is used. In operation, the powder coal is charged from the powder coal storage vessel into the sluice vessel 1 via inlet port 2 while the sluice vessel 1 is at atmospheric pressure. The sluice vessel 1 is closed, and pressurised by injecting nitrogen into the sluice vessel 1.

After the pressure in the sluice vessel 1 is essentially equal to, or higher than that in the feed hopper 11, the load of powder coal is charged into the feed, hopper 11. This way, batches are pressurised and added to a buffer load of the powder coal in the feed hopper 11 to enable a continuous feed flow of powder coal into the reactor at operation pressure.

The feed hopper 11 may be provided with an aeration device in its cone-shaped receiving means 7, for establishing and maintaining a uniform mass flow rate of the coal particulates and gas mixture to the reactor 9. Examples of suitable aeration devices are disclosed in U.S. Pat. No. 4,943,190 and U.S. Pat. No. 4,934,876 and EP-A 0 308 024 which are incorporated by reference. In this form of aeration, a gaseous fluid is introduced in the feed hopper in or close to the cone-shaped receiving means 7, which gaseous fluid is allowed to escape from the vessel together with the solid particulates. There is thus no intent to influence the pressure in the vessel. A preferred embodiment for an aeration device will be discussed later in this specification.

The feed hopper 11 may additionally be provided with means 50 for venting gas from the upper end of the feed hopper 11, for the purpose of maintaining an upward flow of gas from the aeration device through the particulates in the feed hopper 11.

It is believed that, if the pressurisation fluid would only be introduced in the sluice vessel 1 in a space above the load of solid particulates, smaller particulates in the load may be entrained with the flow of pressurisation fluid until the pores between the larger particulates become clogged up and thus a clogged up layer may form. During continued pressurisation, the particulates underneath the clogged up layer would then be compressed as a result of the clogged up layer being pressed down by the overhead pressure, resulting in a heavily compacted load. This may lead to formation of a so-called bridge in the sluice vessel causing obstruction of the discharge port 4.

In accordance with the invention, occurrence of such compaction is avoided from the onset by bringing at least part of the pressurising fluid into the vessel via one or more pressurising fluid inlet means submerged under the load of solid particulates.

FIG. 2 schematically shows in longitudinal cross section a sluice vessel in accordance with an embodiment of the invention. The sluice vessel comprises a pressure shell 3, having a part 31 with a downwardly converging wall, here shown as a conical part of the wall. At the apex thereof a discharge port 4 is provided, to be connected to, for instance, conduit 20 in FIG. 1. The included angle of the conical part is 30°.

Pressurising means, generally indicated by reference number 6 in FIG. 2, is provided on the centre line of the sluice vessel. The elongate device is prevented to move away from the centre line by support means, here shown in the form of two sets of three supports 8 in the form of centering struts in the conical part 31 of the sluice vessel.

The top part 12 of the pressurising means can be formed of a conventional supply pipe, suitably having a diameter of 6 inch. The function of this supply pipe is to carry the nitrogen to a bottom part 13 of the pressurising means, which supports the actual nitrogen inlet means into the load of powder coal.

Referring now to FIG. 3, the connection of the top part 12 to the bottom part 13 is shown in more detail. The top part 12 is in this embodiment connected to the bottom part 13 via cooperating flanges (16,17). The bottom part 13 in this embodiment is provided with a supply passage in the form of an inner pipe 14, and a distributor in the form of a concentrically arranged porous outer pipe 15.

The inner pipe 14 provides the strength of the assembly, and for this reason it is preferably made of a strong material such as solid steel. It also functions as the supply passage for transporting the nitrogen through the distributor. For a proper functioning of the distributor, the inner pipe 14 is preferably provided with a plurality of openings for letting the nitrogen in the sluice vessel. The openings preferably have a diameter smaller than ⅔ of the outer diameter of the inner pipe 14, but larger than 1% of the outer diameter of the inner pipe. A suitable value is approximately 6 mm in a pipe having an outer diameter of 3 inch.

The outer pipe 15 is made of a porous material, for supporting the solid particulates and allowing passage of the nitrogen into the load of powder coal. Suitably, the outer pipe is made of a sintered metal. The outer pipe 15 assures a large nitrogen distribution surface area submerged in the load of powder coal. For maximising the distribution surface area, an annular gap can be left between the inner pipe 14 and the outer pipe 15, which is particularly useful in the case where the openings in the inner pipe cover only a relatively small fraction of the available surface on the inner pipe. An alternative arrangement will, however, be discussed below.

In operation, nitrogen can be supplied through the nozzle 27 at the top of the sluice vessel as shown in FIGS. 2 and 3, after the vessel is almost completely filled with a load of powder coal. In this embodiment, the pressurization device for pressurising the nitrogen can be mechanically supported by the top nozzle.

Referring now to FIGS. 4 to 6 there is shown a preferred embodiment of the invention. As can be seen in FIG. 4, the sluice vessel comprises a pressure shell 3, having a part 41 with a downwardly converging wall, here shown as a conical part of the wall. As in the previous embodiments, a discharge port 4 is provided in the apex of the downwardly converging wall, to be connected to, for instance, conduit 20 in FIG. 1.

The pressurising fluid inlet means is provided in the form of a number of supply passages 22, here embodied as pipes, installed on the inside wall of the conical part 41 of the sluice vessel. The present embodiment employs four pipes, but a different number can be employed, for instance three, five, six, seven, or eight. Each pipe 22 has a number of openings 23 provided with disks or plugs of a porous material, such as a sintered metal as in the above described embodiment. The pipes form a supply passage for transporting the pressurised fluid, preferably in the form of nitrogen. The pipes 22 are connectable to a pressurisation device via ports 25 provided in the downwardly converging part 41 of the sluice vessel side wall, here shown in the form of a flanged design.

The disks of the porous material form the distributor to distribute the nitrogen flow, while the pipes provide the mechanical robustness of the inlet means. Since the pipes 22 are arranged close to the converging wall, they can be very well supported such that deformation by the dynamic forces of the coal inventory is minimised or even prevented, without providing extensive support struts. Therefore, only the pipes 22 themselves could form a possible obstruction to the flow of coal particulates during discharging of the sluice vessel.

In order to further minimise obstruction, the discharge port 4 is in alignment with the longitudinal axis along which the pipes extend. At least, the pipes are arranged to extend radially outward with respect to the discharge port.

Moreover, by providing the inlet means in close vicinity to the downward converging part of the sluice vessel side wall, the rising nitrogen bubbles will be as, much as possible evenly distributed over the entire contents of the powder coal inventory.

Another advantage of providing the pipes in close vicinity with the downward converging part 41 of the sluice vessel side wall, is that this allows for advantageously mounting of the pipes extending in an off-vertical direction. Nitrogen that is passed through the distributors into the load of coal particulates flows essentially vertically upward through the coal. The upward flow of nitrogen though the coal particulates has a liquefying effect on the particulates, which is also abrasive due to the presence of the particulates. By off-vertical mounting, the wear caused by the pressurising fluid travelling through the coal inventory on the tube itself is minimised.

For the same reason, the openings in each pipe 22, preferably numbering between 100 and 180 per pipe, and in the present example 140 in number, each face away from the sluice vessel side wall 41 that the respective pipe 22 is mounted on.

The pipes are replaceable during a maintenance shut down, and easy to repair. Maintenance on the porous metal disks or plugs can be delegated to the manufacturer. Alternatively, the pipes can be refurbished by replacing fouled or damaged disks or plugs.

FIG. 5 shows a detailed side view (FIG. 5a) and front view (FIG. 5b) of the pipes 22. Each opening in the pipe is provided with a disk 24 of the porous material. In this way, the mechanically relatively weaker disks 24 are mechanically supported by the mechanically stronger pipe arrangement.

FIG. 6 shows a cross sectional view of a pipe 22 in the direction along the axis. The opening 23 provided in the pipe has a diameter of approximately 65 mm, and is provided with an insert 28 for mounting the disk 24, of the porous material. The disk 24 has a diameter of 55 mm, and is held in place by means of a fillet weld 26 such that a diameter of 50 mm remains available. The thickness of the disk is 10 mm.

A similar construction of the supply passage, whereby instead of the outer pipe 15, the distributor is provided in the form of disks or plugs in openings in the inner pipe 14 can be adopted in the embodiment of FIG. 1.

As an alternative, but less preferred, the combination of outer pipe 15 and inner pipe 14 in FIG. 1 can be replaced by a single pipe, being formed of a string of alternatingly joined sections of impermeable pipe pieces and distributor pipe pieces made of a porous material. However, such a string of sections is constructionally difficult to obtain and can be mechanically weak compared to the embodiment wherein the distributor is provided in the form of disks or plugs in openings perforating the side wall of a solid pipe piece.

FIG. 7 shows a detailed cross sectional view of an alternative embodiment. As in the previous embodiments, the sluice vessel comprises a pressure shell 3, having a part 51 with a downwardly converging wall, here shown as a conical part of the wall. At the apex thereof a discharge port 4 is provided to be connected to, for instance, conduit 20 in FIG. 1.

In this embodiment, the pressurising fluid inlet means is provided in the form of a liner 18 arranged inside the conical part 51 of the wall leaving a space 19 between the outside shell wall and the liner 1B as supply passage. The outside wall is provided with one or more connecting nozzles 37 for supply of the pressurised nitrogen into the space 19.

The liner may essentially be formed of the porous material such as the sinter metal material as used for the outer pipe in FIG. 3, and thus essentially acting as the distributor. This is shown in FIG. 7 on the right hand side of the cross section. Much in the same way as in the embodiment of FIG. 3, this assures a large nitrogen distribution surface area submerged in the load of powder coal.

Alternatively, and this is schematically shown on the left hand side of FIG. 7, the liner 18 may be formed of a strong material such as solid steel provided with openings and a distributor in the form of disks or plugs of the porous material similar to what is shown in the second embodiment. In the latter case, the strong material provides the mechanical strength to the arrangement, whereby the distributor is supported by the strong material.

In the above described embodiments, suitable porous material is sinter material, preferably sinter metal, more preferably sinter stainless steel, such as 316 L stainless steel elements, pre-fabricated by GKN Sinter Metals GmbH, Dahlienstrasse 43, D-42477 Radevormwald, Germany. Other sinter materials may also be used, such as sinter glass.

It is better to have a large number of small pores than a small number of large pores.

The diameter of the pores should be large enough to let the gas pass, but not too large, so that coal particles are prevented to enter the tubing. Suitable diameters are between 1 and 50 μm, preferably 1 to 20 μm, more preferably 7 to 14 μm. The pores are more preferably selected to allow a pressure build-up to a pressure that is higher, preferably at least 5 bar higher, than the pressure in the feed hopper 11 in a time period of 10 minutes or less, more preferably 5 minutes or less. Suitable pressures in the sluice vessel in its high pressure state are for instance 10 to 80 bar, or 25 to 80 bar or 35 to 80 bar.

Consequently, the provided pressurising means is arranged to increase the pressure inside the sluice vessel by at least 10 bar, preferably by at least 11 bar, more preferably by at least 25 bar, even more preferably by at least 41 bar.

It is remarked that in any of the embodiments described above, the pressurising means, and in particular the pressurizing fluid inlet means, can be utilised as aerating means for aerating the load during discharging to facilitate the discharge of the coal particulates and gas mixture to the reactor feed hopper 11.

In such an embodiment, an aeration fluid supply is fluidly connected to the one or more pressurising fluid inlet means to inject an aeration fluid from the aeration fluid supply into the load of the solid particulates while the discharge port is open.

Preferably, the aeration fluid supply is arranged to inject the aeration fluid at a pressure that exceeds the pressure in the pressurised pressure vessel. Herewith a proper functioning of the aeration device is ensured, and the discharge of the solid particulates into the pressurized vessel is facilitated.

Preferably, the aeration fluid supply is arranged to provide the aeration fluid at an elevated pressure for injecting the aeration fluid at a volumetric rate that exceeds a volumetric discharge rate of the solid particulates from the sluice vessel through the open discharge port. A compressor may be provided for bringing the aeration fluid to an elevated pressure, or the aeration fluid may, for instance, be extracted from a storage facility, where it is kept under pressure.

The aeration fluid supply can be part of, the pressurising means, or the pressurising means for bringing the sluice vessel in its high pressure state can replace a separate aeration fluid supply.

In particular, the embodiment as shown and described with reference to FIGS. 4 to 6, forms an improved aeration device for aerating the load of solid particulates in any type of hopper vessel, for instance during charging of a load into the hopper vessel or discharging the load from the hopper vessel, the hopper vessel having a receiver part with a downwardly converging wall at an apex thereof provided with a discharge port for discharging the load, the receiver part being provided with an aerator for aerating the load, the aerator being connectable to a supply of a pressurised aeration fluid, the aerator comprising one or more aeration fluid inlets for injecting the aeration fluid into the load, wherein the one or more aeration fluid inlets are provided in one or more tubular members positioned on or close to the converging wall. The hopper vessel can be of any type, including a sluice vessel or a feed hopper, for temporarily holding a load of solid particulates.

Although the invention set out above has been described primarily with reference to pulverized coal, the method and apparatus according to the invention are also suitable for reactive solids and other finely divided solid fuels which could be partially combusted, such as lignite, anthracite, bituminous, brown coal, soot, petroleum coke, and the like. Advantageously, the size of solid carbonaceous fuel is such that 90% by weight of the fuel has a particle size smaller than 100 mesh (A.S.T.M.).

Additionally, the present invention can be used for any one of granular, pulverized, and powdered solids such as resins, catalysts, fly ash, bag house and electro-static precipitator fines.

1. A hopper vessel for temporarily holding a load of solid particulates, having a receiver part with a downwardly converging wall that is at an apex thereof provided with a discharge port for discharging the load, which receiver part is provided with an aerator for aerating the load, the aerator comprising a supply passage in the form of a tubular member connectable to a supply of a pressurised aeration fluid or pressurising fluid whereby the pressurized aeration fluid or pressurising fluid is transportable through the supply passage, whereby the tubular member comprises a side wall that is provided with one or more openings perforating the tubular member side wall, for allowing passage of the pressurized aeration fluid or the pressurising fluid from the supply passage into the hopper vessel, which tubular member is positioned on or close to the converging wall.

2. A hopper vessel according to claim 1, wherein the supply passage is connectable to a pressurisation device.

3. A hopper vessel according to claim 2, wherein the tubular member extends in a substantially off-vertical direction.

4. A hopper vessel according to claim 3, wherein the one or more openings in the supply passage side wall face an upward direction.

5. A hopper vessel according to claim 4, wherein the tubular supply passage extends along a longitudinal tube axis, and the discharge port is in alignment with the longitudinal tube axis.

6. A hopper vessel according to claim 5, wherein the one or more openings are provided with a distributor comprising a porous material, for supporting the solid particulates and allowing passage of pressurized aeration fluid or the pressurising fluid.

7. A hopper vessel according to claim 6, wherein there is a discharge zone defined inside the hopper vessel which discharge zone stretches vertically above the discharge port, whereby the supply passage is provided outside the discharge zone.

8. A hopper vessel according to claim 7, wherein the one or more openings are arranged to bring pressurized aeration fluid or the pressurising fluid into the hopper vessel in a direction facing away from the converging wall.

9. A sluice vessel for feeding solid particulates into a pressurized pressure vessel, the sluice vessel in use having a low pressure state and a high pressure state, the sluice vessel comprising means for charging the sluice vessel with a load of the solid particulates when the sluice vessel is in its low pressure state, at least one discharge port, and pressurising means for increasing the pressure inside the sluice vessel by bringing a pressurising fluid into the sluice vessel, to bring the sluice vessel into its high pressure state before discharging the load via the discharge port, whereby the pressurising means comprises one or more pressurising fluid inlet means arranged to be submerged under the load of solid particulates, the pressurising fluid inlet means comprising a supply passage in the form of a tubular member for transporting the pressurising fluid whereby the tubular member comprises a side wall that is provided with one or more openings perforating the tubular member side wall, for allowing passage of the pressurising fluid from the supply passage into the sluice vessel.

10. A sluice vessel according to claim 9, wherein the tubular member extends in a substantially off-vertical direction whereby the one or more openings face an upward direction.

11. A sluice vessel according to claim 10, wherein the one or more openings are provided with a distributor comprising a porous material, for supporting the solid particulates and allowing passage of the pressurising fluid, which distributor is mechanically supported by the supply passage for withstanding a pressure difference across the distributor corresponding to at least the pressure difference between the low pressure state and a high pressure state.

12. A sluice vessel according to claim 11, wherein there is a discharge zone defined inside the sluice vessel which discharge zone stretches vertically above the discharge port, whereby the supply passage is provided outside the discharge zone.

13. A sluice vessel according to claim 12, having a part with a downwardly converging wall forming at an apex thereof the at least one discharge port, wherein the pressurising fluid inlet means are arranged in, on, or close to the converging wall.

14. A sluice vessel according to claim 13, wherein the pressurising fluid inlet means are arranged to bring the pressurising fluid into the sluice vessel in a direction facing away from the converging wall.

15. A method of operating a sluice vessel for feeding solid particulates into a pressurised pressure vessel, the sluice vessel comprising at least one discharge port, wherein the sluice vessel is brought from a low pressure state to a high pressure state, comprising the steps of:
charging the sluice vessel with a load of the solid particulates when the sluice is in its low pressure state;
bringing the sluice vessel into its high pressure state, before discharging the load via the discharge port, by bringing a pressurising fluid into the sluice vessel thereby increasing the pressure inside the sluice vessel;
whereby at least part of the pressurising fluid is brought into the sluice vessel via one or more pressurising fluid inlet means provided as one or more openings perforating a tubular member side wall submerged under the load of solid particulates.

16. A method according to claim 15, further comprising the step of discharging the load via the discharge port, while aerating the load by allowing a flow of an aeration fluid through the one or more pressurising fluid inlet means.

17. A method according to claim 16, wherein the aeration fluid is actively injected into the load of the solid particulates, whereby a selected pressure and a selected volumetric rate of the aeration fluid is controlled.
